(19) United States
(12) Patent Application Publication
(10) Pub. No.: US 2017/0303507 A1
(43) Pub. Date: Oct. 26, 2017

(54) PET GROOMING DEVICE

(71) Applicant: FURING LIMITED LIABILITY COMPANY, TAICHUNG CITY (TW)

(72) Inventor: CHEN PIN KUO, TAICHUNG CITY (TW)

(21) Appl. No.: 15/472,663

(22) Filed: Mar. 29, 2017

(30) Foreign Application Priority Data
Apr. 22, 2016 (TW) 105112580

(51) Int. Cl. A01K 13/00

(52) U.S. Cl. CPC A01K 13/004

(57) ABSTRACT

A pet grooming device includes a first positioning member and a second positioning member. The second positioning member includes one or more assembling hole. The assembling hole includes a grooming brush. The first positioning member and the second positioning member are combined with each other.

### BACKGROUND OF THE INVENTION

### Field of the Invention

The present invention relates to a grooming brush, in particular to grooming brush for removing unwanted hairs of the pet.

### Description of the Prior Art

Many people like to feed pets, for example, dogs or cats. Some breeds of the dogs or cats may have longer hairs, and the hairs may be curled or knotted because of dirt. Because of the owner' love to the pets or because of the concern about health and beauty of the pets, the owner may use brush to groom the hairs of the pet to remove the dirt or to open the knots. Hence, the hairs of the pet can be arranged.

However, the pets are uncontrollable and wild, and usually the pet cannot stay stationary and wait its owner to groom hair, resulting in inconvenience of the user. On the other hand, the owner may be too busy to groom the pet's hair. Consequently, health and beauty of the pets can hardly be kept.

### SUMMARY OF THE INVENTION

One object of the present invention is to provide a pet grooming device. The pet grooming device is assembled to a case having a via hole. Therefore, by utilizing a pets' nature that pets like to pass through holes and hide themselves, when the pet passes through the via hole, the pet's body is groomed by the grooming brush, so that the pet can be groomed.

In view of these objects, the present invention provides a pet grooming device comprising:
a first positioning member;
a second positioning member correspondingly combined with the first positioning member, the second positioning member comprising at least one assembling hole, and the at least one assembling hole comprises a grooming brush.

In one embodiment, the second positioning member extends an extension section toward the first positioning member, and the first positioning member and the extension section has threaded portions, so that the first positioning member and the extension section are threaded with each other via the threaded portions.

In one embodiment, the first positioning member and the second positioning member are respectively annular shaped, a through hole is formed in the first positioning member, and a through hole is formed in the second positioning member. Each of the through holes has a center, and the grooming brush extends toward the center.

In one embodiment, a periphery of the second positioning member has a plurality of sections each having a same size, parts or all of the sections comprises the assembling holes. Moreover, sections comprising the assembling holes are adjacently connected to each other.

In one embodiment, the first positioning member and the second positioning member are respectively at two sides of a positioning end, and the first positioning member and the second positioning member sandwich the positioning end after the first positioning member and the second positioning member are combined with each other.

In one embodiment, the positioning end is a via hole assembled to a case.

### BRIEF DESCRIPTION OF THE DRAWINGS

FIG. 1 illustrates an exploded view of a pet grooming device according to an exemplary embodiment of the present invention;

FIG. 2 illustrates a partial exploded view of a second positioning member of the pet grooming device;

FIG. 3 illustrates a sectional view of an assembly of the pet grooming device and a case;

FIG. 4 illustrates an operational view of the pet grooming device;

FIG. 5 illustrates a perspective view of an assembly of the pet grooming device and two cases; and

FIG. 6 illustrates a sectional view of the assembly of the pet grooming device and the two cases.

### DETAILED DESCRIPTION OF THE PREFERRED EMBODIMENTS

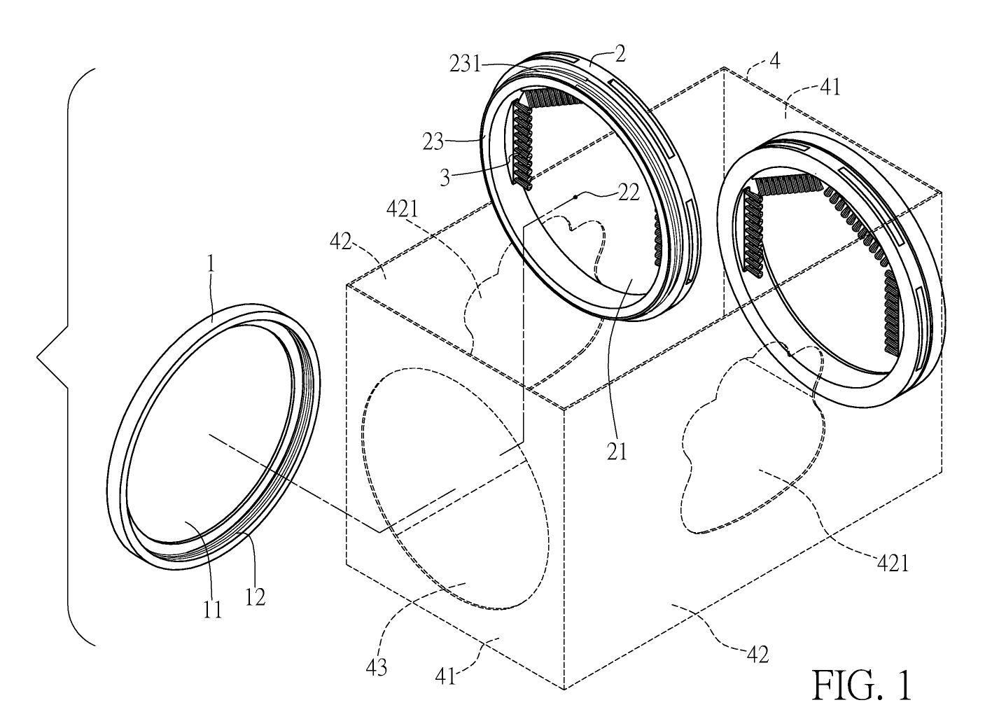

Please refer to FIG. 1, illustrating a pet grooming device according to exemplary embodiment of the present invention. The pet grooming device comprises a first positioning member 1 and a second positioning member 2. In this embodiment, the first positioning member 1 and the second positioning member 2 are respectively annular shaped. A through hole 11 is formed in the first positioning member 1, and a through hole 21 is formed in the second positioning member 2. The through hole 21 of the second positioning member 2 has a center 22.

As above, the first positioning member 1 is correspondingly combined with the second positioning member 2. In this embodiment, the second positioning member 2 extends an extension section 23 toward the first poisoning member 1. The extension section 23 is extended from an inner periphery of the second positioning member 2 and of annular shaped. The extension section 23 has an outer threaded portion 231. On the other hand, the first positioning member 1 has an inner threaded portion 12 corresponding to the outer threaded portion 231, and the inner threaded portion 12 is at an inner periphery of the first positioning member 1. Accordingly, the first positioning member 1 and the second positioning member 2 can be threaded with each other via the inner threaded portion 12 and the outer threaded portion 23, so that the first positioning member 1 can be combined with the second positioning member 2.

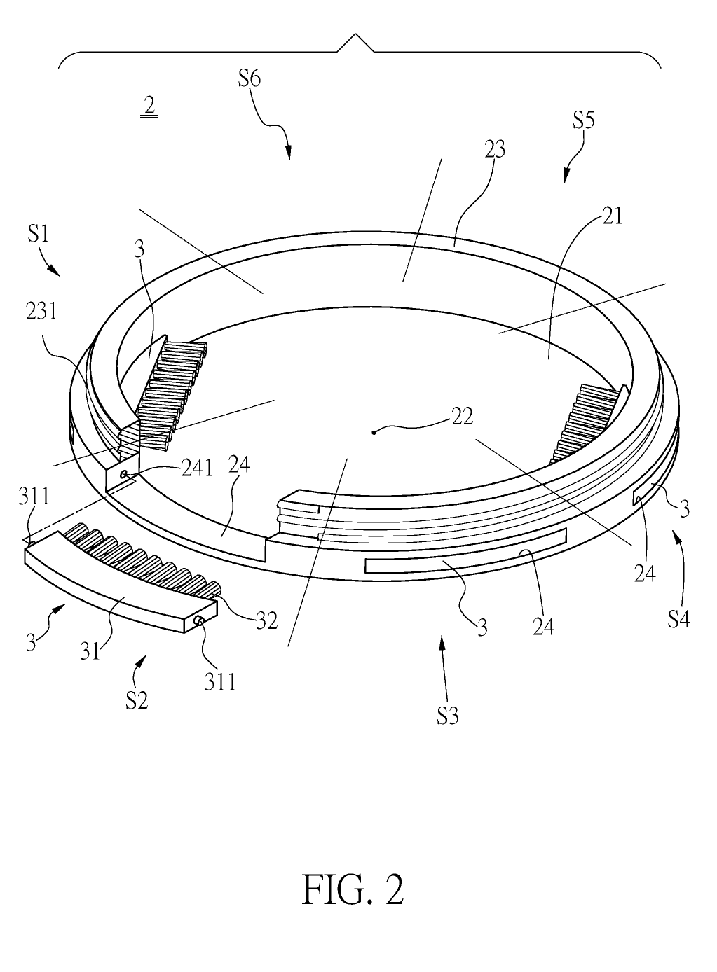

The second positioning member 2 comprises at least one grooming brush 3. As shown in FIG. 2, the second positioning member 2 comprises at least one assembling hole 24, and the grooming brush 3 is assembled in the assembling hole 24. In this embodiment, the outer periphery of the second positioning member 2 is divided into six equal sections S1-S6, four of the sections S1-S4 respectively comprise the assembling holes 24, and each of the assembling holes 24 is defined through the second positioning member 2 in a radial direction of the second positioning member 2. Furthermore, the sections S1-S4 comprising the assembling holes 24 are adjacently connected to each other. In another embodiment, all of the sections S1-S6 comprise the assembling holes 24.

Each of the assembling holes 24 comprises one grooming brush 3, and each of two sides of the assembling hole 24 has an engaging hole 241. The grooming brush 3 comprises a base 31 and a plurality of bristles 32. Each of two sides of the base 31 comprises a protruding block 311. Accordingly, when the grooming brush 3 is assembled in the assembling hole 24, the protruding blocks 311 are engaged in the engaging holes 241 so that the grooming brush 3 is positioned in the assembling hole 24.

After the grooming brush 3 is assembled in the assembling hole 24 according to the aforementioned operation, the bristles 32 extend out of the assembling hole 24 and into the through hole 21 of the second positioning member 2. Furthermore, the bristles 32 extend toward the center 22 of the through hole 21.

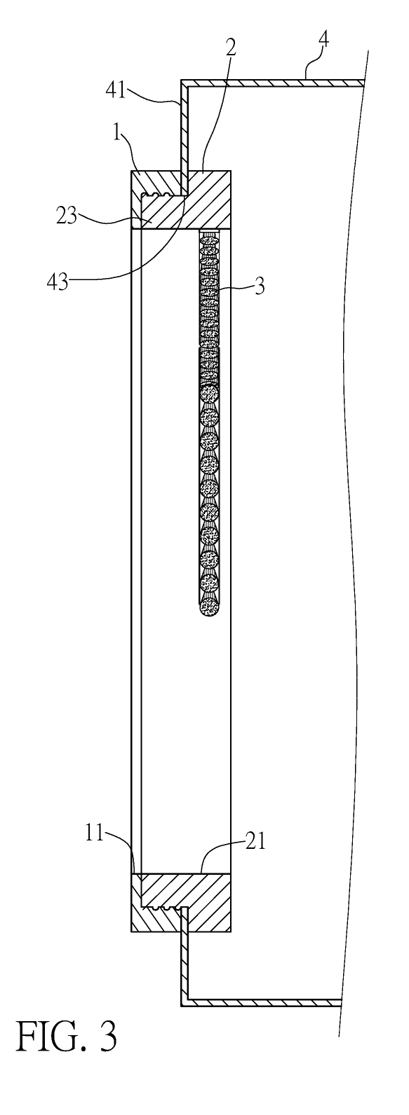

The pet grooming device according to the present invention is described as above. The pet grooming device may be combined with one or more case. As shown in FIG. 1, the case 4 has four sidewalls 41, 42, and the sidewalls 41 have via holes 43 defined through the case 4. As shown in FIG. 3, the first positioning member 1 and the second positioning member 2 are respectively assembled at an inner side and an outer side of the case 4 and are respectively at two sides of the via hole 43. The second positioning member 2 is at one of the two sides of the via hole 43, the extension section 23 passes through the via hole 43 to the other side of the via hole 43, and then the extension section 23 is combined with the first positioning member 1. Accordingly, the through hole 11 of the first positioning member 1, the through hole 21 of the second positioning member 2, and the via holes 43 of the sidewalls 41 form a channel, and the first positioning member 1 and the second positioning member 2 sandwich the sidewall 41 after the first positioning member 1 and the second positioning member 2 are combined with each other.

As shown in FIG. 1, the sidewalls 42 of the case 4 may have decorating holes 421 in various patterns for decorating purposes. Besides, the decorating holes 421 may be used to allow the user to insert his/her hand into the case 4 to hold the first positioning member 1 or the second positioning member 2, and the other hand of the user holds the other positioning member for combining the first positioning member 1 with the second positioning member 2.

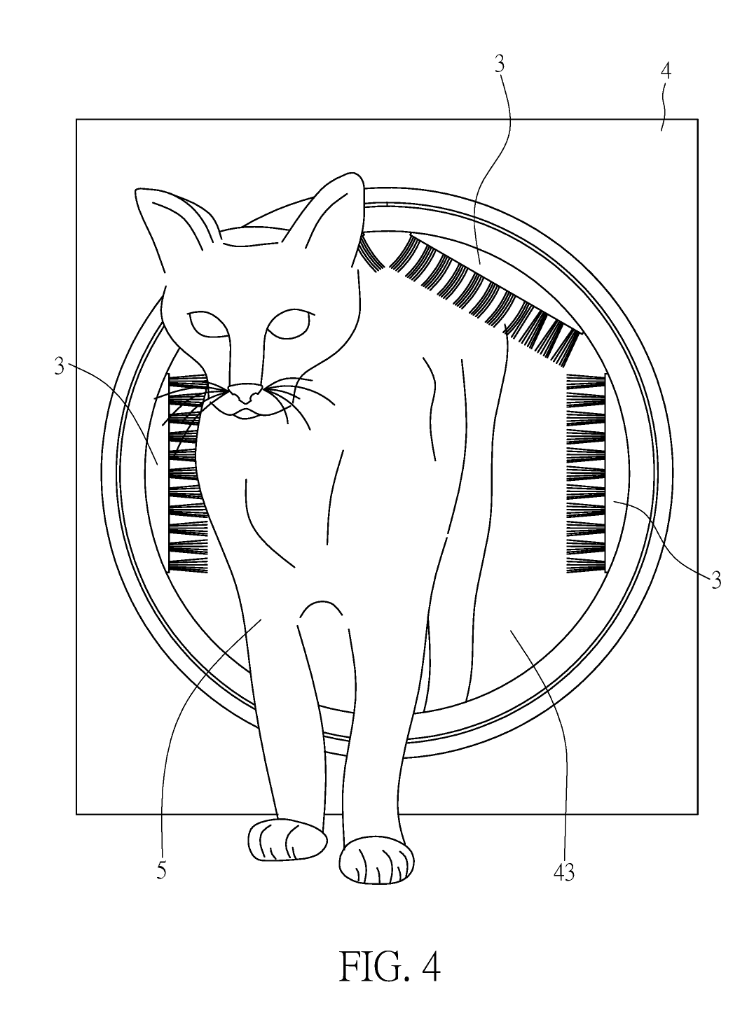

According to the assembly of the pet grooming device and the case 4, the pet can be groomed by utilizing a pets' nature that pets like to hide themselves in the case. As shown in FIG. 4, when the pet 5 passes through the via hole 43, the body of the pet 5 is in contact with the grooming brush 3, so that the hairs of the pet 5 is groomed, and the unwanted hairs or dusts can be removed from the pet 5 and left at the grooming brush 3. Hence, the time and effort of the owner for grooming the pet can be saved, and the pet may be groomed to keep the health and the beauty of the pet during the pet plays.

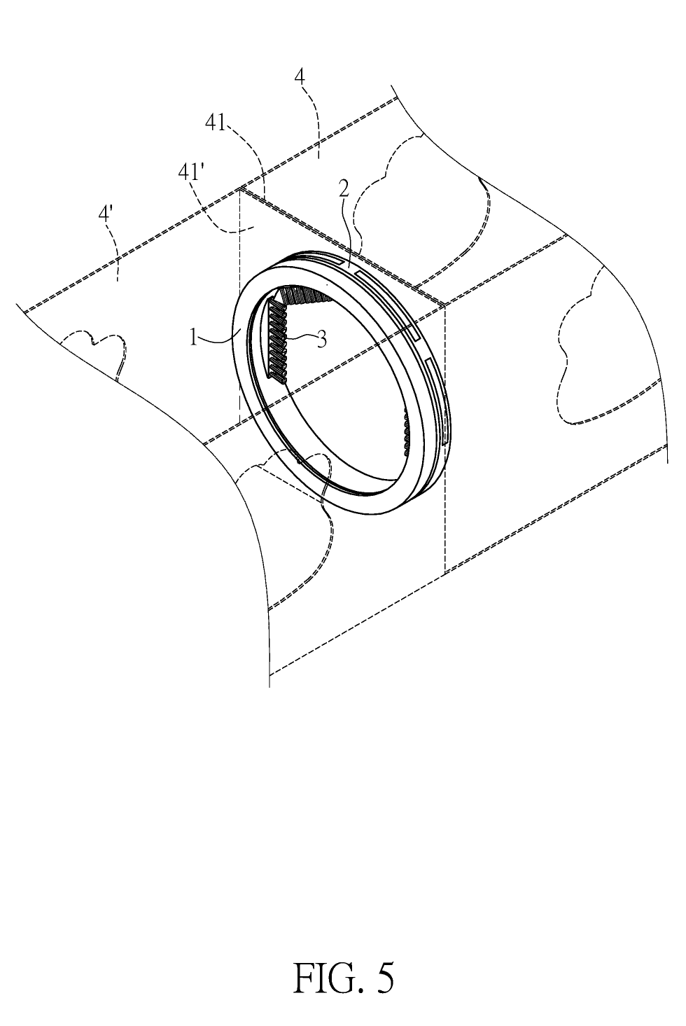

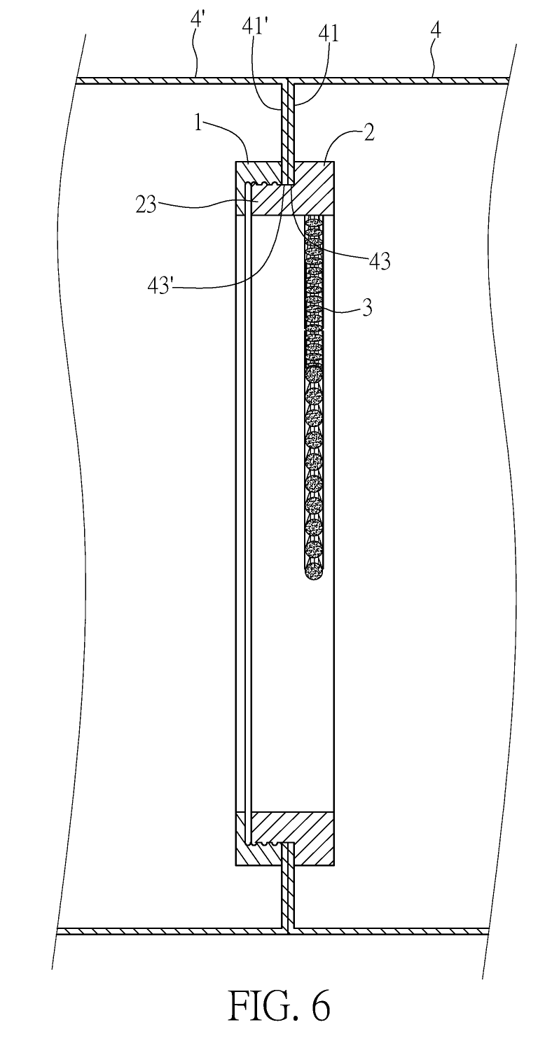

Furthermore, the pet grooming device may be assembled with the case in another way. As shown in FIGS. 5 and 6, the sidewalls 41, 41′ of the cases 4, 4′ are attached with each other, so that the via hole 43 of case 4 and the via hole 43′ of the case 4 are in communication with each other. The first positioning member 1 and the second positioning member 2 are respectively at inner sides of the cases 4, 4′. The second positioning member 2 is in the case 4, and the extension section 23 passes through the via holes 43, 43′, inserts into the case 4′, and combined with the first positioning member 1 by threading. Accordingly, the first positioning member 1 and the second positioning member 2 sandwich the sidewalls 41, 41′ of the cases 4, 4′ after the first positioning member 1 and the second positioning member 2 are combined with each other. Hence, the cases 4, 4′ can be connected with each other to form a larger space for the pet to play. Furthermore, in this embodiment, the pet will pass through the via holes 43, 43′ of the cases 4, 4′ more frequently, and the times the grooming brush 3 applies to the pet also increases.

What is claimed is:

1. A pet grooming device, comprising:
a first positioning member;
a second positioning member correspondingly combined with the first positioning member, the second positioning member comprising at least one assembling hole, and the at least one assembling hole comprises a grooming brush.

2. The pet grooming device according to claim 1, wherein the second positioning member extends an extension section toward the first positioning member, and the first positioning member and the extension section has threaded portions, so that the first positioning member and the extension section are threaded with each other via the threaded portions.

3. The pet grooming device according to claim 1, wherein the first positioning member and the second positioning member are respectively annular shaped, a through hole is formed in the first positioning member, and a through hole is formed in the second positioning member.

4. The pet grooming device according to claim 3, wherein each of the through holes has a center, and the grooming brush extends toward the center.

5. The pet grooming device according to claim 4, wherein a periphery of the second positioning member has a plurality of sections each having a same size, parts or all of the sections comprises the assembling holes.

6. The pet grooming device according to claim 5, wherein sections comprising the assembling holes are adjacently connected to each other.

7. The pet grooming device according to claim 1, wherein the first positioning member and the second positioning member are respectively at two sides of a positioning end, and the first positioning member and the second positioning member sandwich the positioning end after the first positioning member and the second positioning member are combined with each other.

8. The pet grooming device according to claim 7, wherein the positioning end is a via hole assembled to a case.
